(19) United States
(12) Patent Application Publication
(10) Pub. No.: US 2022/0343159 A1
(43) Pub. Date: Oct. 27, 2022

(54) TECHNICAL SPECIFICATION MATCHING

(71) Applicant: NEC Laboratories America, Inc., Princeton, NJ (US)

(72) Inventors: Yanchi Liu, Monmouth Junction, NJ (US); Haifeng Chen, West Windsor, NJ (US); Xuchao Zhang, Elkridge, MD (US)

(21) Appl. No.: 17/720,431

(22) Filed: Apr. 14, 2022

Related U.S. Application Data
(60) Provisional application No. 63/177,406, filed on Apr. 21, 2021.

(51) Int. Cl. G06N 3/08; G06F 16/33

(52) U.S. Cl. CPC G06N 3/08; G06F 16/3347

(57) ABSTRACT

Systems and methods are provided for detail matching. The method includes training a feature classifier to identify technical features, and training a neural network model for a trained importance calculator to calculate an importance value for each identified technical feature. The method further includes receiving a specification sheet including a plurality of technical features, and receiving a plurality of descriptive sheets each including a plurality of technical features. The method further includes identifying the technical features in the specification sheet and the plurality of descriptive sheets using the trained feature classifier, and calculating an importance for each identified technical feature using the trained feature importance calculator. The method further includes calculating a matching score between the identified technical features of the specification sheet and the identified technical features of the plurality of descriptive sheets based on the importance of each identified technical feature.

### RELATED APPLICATION INFORMATION

This application claims priority to U.S. Provisional Application No. 63/177,406, filed on Apr. 21, 2021, which is incorporated herein by reference in its entirety.

### BACKGROUND

### Technical Field

The present invention relates to using trained language models to match technical specifications and more particularly identifying relevant technical features for hierarchical matching of the technical specifications.

### Description of the Related Art

Word embeddings, learned from massive unstructured text data, are widely-adopted building blocks for natural language processing (NLP), such as document classification, sentence classification, and natural language sequence matching. In the same spirit of learning distributed representations for natural language, many NLP applications also benefit from encoding word sequences (e.g., a sentence or document) into a fixed-length feature vector.

### SUMMARY

According to an aspect of the present invention, a method is provided for detail matching. The method includes training a feature classifier to identify technical features, and training a neural network model for a trained importance calculator to calculate an importance value for each identified technical feature. The method further includes receiving a specification sheet including a plurality of technical features, and receiving a plurality of descriptive sheets each including a plurality of technical features. The method further includes identifying the technical features in the specification sheet and the plurality of descriptive sheets using the trained feature classifier, and calculating an importance for each identified technical feature using the trained feature importance calculator. The method further includes calculating a matching score between the identified technical features of the specification sheet and the identified technical features of the plurality of descriptive sheets based on the importance of each identified technical feature.

According to another aspect of the present invention, a computer system is provided for detail matching. The system includes one or more processors, a computer memory in electronic communication with the one or more processors, and a display screen in electronic communication with the computer memory and the one or more processors, wherein the computer memory includes a feature classifier trained to identify technical features, a neural network model configured as a trained importance calculator for calculating an importance value for each identified technical feature, text data including a specification sheet including a plurality of technical features, and a plurality of descriptive sheets each including a plurality of technical features, wherein the trained feature classifier identifies the technical features in the specification sheet and the plurality of descriptive sheets, a feature importance calculator to calculate an importance for each identified technical feature using the trained feature importance calculator, and a feature matching system to calculate a matching score between the identified technical features of the specification sheet and the identified technical features of the plurality of descriptive sheets based on the calculated importance of each identified technical feature, wherein a closest matching product is presented to a user on the display screen.

According to another aspect of the present invention, a non-transitory computer readable storage medium comprising a computer readable program for detail matching is provided. The computer readable program when executed on a computer causes the computer to perform the steps of training a feature classifier to identify technical features, and training a neural network model for a trained importance calculator to calculate an importance value for each identified technical feature. The computer readable program when executed on a computer also causes the computer to perform the steps of receiving a specification sheet including a plurality of technical features, receiving a plurality of descriptive sheets each including a plurality of technical features, and identifying the technical features in the specification sheet and the plurality of descriptive sheets using the trained feature classifier. The computer readable program when executed on a computer also causes the computer to perform the steps of calculating an importance for each identified technical feature using the trained feature importance calculator, and calculating a matching score between the identified technical features of the specification sheet and the identified technical features of the plurality of descriptive sheets based on the importance of each identified technical feature.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system/method for matching technical user needs to manufacturer/developer descriptions is illustratively depicted in accordance with one embodiment of the present invention;

FIG. 2 is a block/flow diagram illustrating a system/method for a feature/entity classifier, in accordance with an embodiment of the present invention;

FIG. 3 is a block/flow diagram illustrating a system/method for an entity importance recognizer, in accordance with an embodiment of the present invention;

FIG. 4 is a block/flow diagram illustrating a process of receiving specification sheet(s) provided by a user/consumer and descriptive material from vendors/manufacturers/developers to identify computer systems/software that best meets the buyer's technical specifications, in accordance with an embodiment of the present invention; and

FIG. 5 illustrates a computer system for detail matching, in accordance with an embodiment of the present invention.

### DETAILED DESCRIPTION OF PREFERRED EMBODIMENTS

In accordance with embodiments of the present invention, systems and methods are provided for matching technical specifications of hardware and software of consumers with the technical specifications of producers' hardware and software descriptions. Many times end users desire particular capacities of hardware systems and software applications, but the descriptions used by the manufactures and software developers do not directly coincide with the detailed language used by the prospective consumer. The technical descriptions provided by vendors also can be complex and use technical jargon that is not easily relatable, requiring technically trained people to review the descriptive materials. Searching for appropriate systems and software can be made more efficient by utilizing trained artificial intelligence to pool descriptive materials and identify hardware and/or software that meets the customer's needs. The hardware and software also may not have the customer's desired capabilities, so determinations of which products come closet in multiple categories may be analyzed and determined.

In addition, the technical specifications published by the manufacturers and developers are not always available in a single document or from a single source, and the material provided by multiple sources is scattered across electronic and print publications, as well as the vendors' websites.

In various embodiments, multiple sources of hardware/software technical descriptions from suppliers, manufacturers, and/or application developers are pooled and analyzed using natural language programming (NLP) that can extract technical information from a description of technical features intended for procurement and from descriptive materials provided by multiple manufactures and/or suppliers. A matching set of technical details can be generated even when the language used in the descriptive materials and the procurement materials are different.

In various embodiments, the entities that are relevant to the business need expression of the consumer also can be extracted, and analysis can be focused on such entities. Different importance can be assigned to different entities to emphasize the importance and applicability of particular ones.

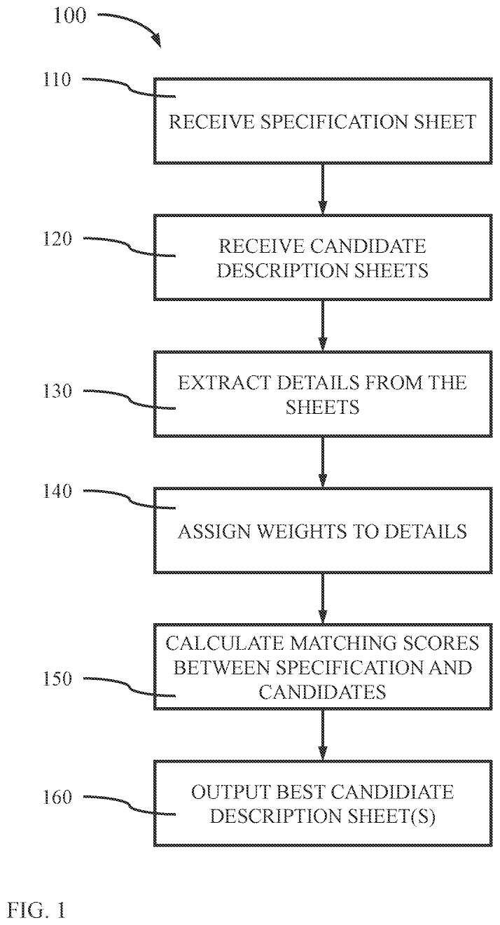

Referring now in detail to the figures in which like numerals represent the same or similar elements and initially to FIG. 1, a high-level system/method for matching technical user needs to manufacturer/developer descriptions is illustratively depicted in accordance with one embodiment of the present invention.

In one or more embodiments, a matching process 100 can involve collecting a user's/consumer's needs document, for example, a request for pricing/proposal (RFP), and vendor description literature, for example, sales brochures, web pages, technical specification sheets and white papers, where the collected documents and literature include text data. The features and details can be extracted the from the pooled descriptive materials, including the documents, web pages, and literature (i.e., text data). Pairs of the technical need document (i.e., specification sheet) and the vendor descriptions can be generated, and a matching score calculated for each pair of specification sheet and vendor description. The highest scoring pair(s) can be provided to the user/consumer for consideration for procurement.

At block 110, a specification sheet(s) provided by a user/consumer can be received and inputted into an extractor. The specification sheet may describe desired features, properties, capabilities, and characteristics of a product in specific terminology and language, that may be different from a producer's description. The specification sheet may describe desired properties, such as processor cores, processor speed, amount of memory, floating point calculation rates, memory transfer rates, data communication rates, communication port capacities, network security properties, etc.

At block 120, collected descriptive material from vendors/manufacturers/developers can be pooled and inputted into the extractor. The pooled descriptive material can be associated with the vendor/manufacturer/developer entity that supplied the pooled descriptive material.

At block 130, features and details (collectively referred to as features) can be extracted from each of the specification sheet(s) and the pooled descriptive materials. The extracted features and details can include the technical specifications, as well as the business entities that provided the specification sheet(s) and the pooled descriptive materials. The technical features/details and business entities can be extracted by a trained classifier. Each document can be segmented into sentences, and the features extracted sentence by sentence using the trained classifier, where the classifier can be trained using external data unrelated to the specification sheets and descriptive materials.

At block 140, an importance value can be assigned to each of the technical details and extracted entities, where the importance value can be a weight assigned to each technical detail and extracted entity for use in a matching score calculation. The weights can be assigned by a trained neural network importance model.

At block 150, a matching score can be calculated for each of the descriptive materials in relation to the specification sheet(s). The matching score can be based on each pair formed by the specification sheet(s) and one of the descriptive materials. The matching score can be calculated based on the weighted sum of feature similarities from different features and entities extracted from the specification sheet(s) and the descriptive materials.

At block 160, a ranked list of the descriptive materials can be provided to a user to identify the system/application that best meets the needs of the user/consumer, where the entity associated with each of the descriptive materials can also be identified and provided. The user/consumer can use the ranked list to identity a vendor entity and system/application that best meets their needs, and initiate a procurement process with the related business entity.

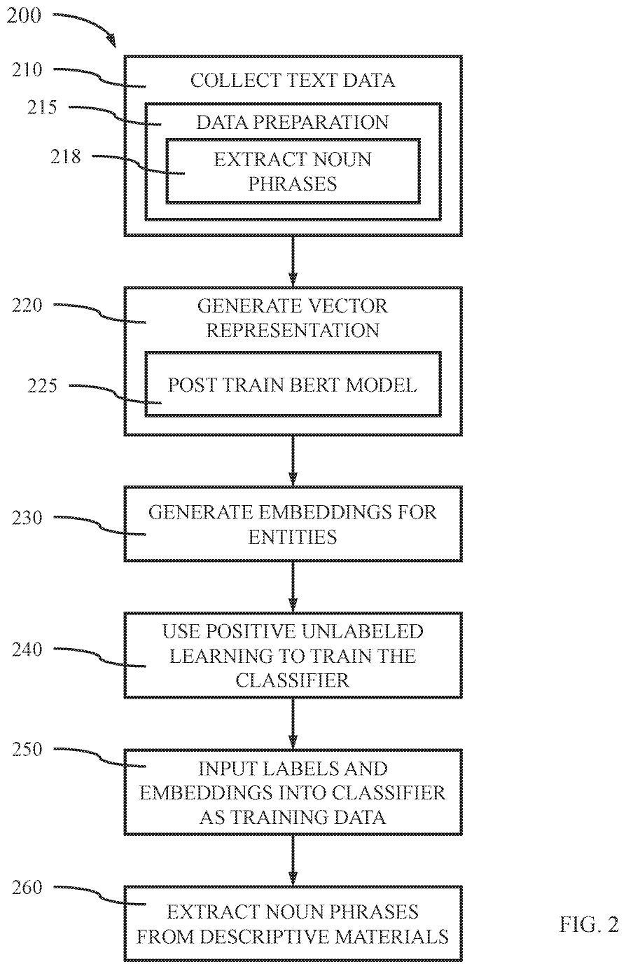

Referring now to FIG. 2, a block/flow diagram of a system/method for a feature/entity classifier, in accordance with an embodiment of the present invention.

In one or more embodiments, a feature/detail classifier 200 can be trained to identify the technical features and business entity related to each particular item of descriptive material (e.g., sales brochures, web pages, technical specification sheets and white papers) that may be collected as text data. Labels may not be available for the technical features and business entities identified in the specification sheet(s) provided by a user/consumer or the descriptive materials provided by the vendors. External data can be used for data augmentation, and the knowledge transferred from other domains to the need document (specification sheet) domain.

At block 210, the text data of the descriptive material can be collected, where the descriptive material can be collected by requesting materials from vendors, downloading documents from websites, web page scraping, magazine/trade paper scanning and optical character recognition, as well as other gathering methods. The collected descriptive material can be pooled in a database for later retrieval and use.

At block 215, the text data of the descriptive material can be prepared by segregating the text of the descriptive materials into sentences and noun phrases. Each document (e.g., specification sheet, descriptive sheet, web page, etc.) can be segmented into sentences, and the details/features can be extracted sentence by sentence using a trained feature classifier.

At block 218, noun phrases can be extracted from the text data and the noun phrases identified as relating to technical features and details or business entities. The business entities can be identified using a named entity recognition (NER) tool. The technical features and details can be identified using a trained natural language processing (NLP) model.

At block 220, a vector representation of the sentences and/or noun phrases for the identified entity and technical details/features can be generated using a trained Bidirectional Encoder Representations from Transformers (BERT) model. In various embodiments, the vector representation can be generated by a post-trained BERT model to generate the word embeddings for positive and unlabeled entities and features, where positive means the need document/descriptive material pair is a match. A teacher model flea (e.g., a pre-trained language model) can be used to assign pseudo-labels to unlabeled data that is used to train a student model fₛₜᵤ. Given a pre-trained language model (e.g., BERT) as the teacher model, we first use the distant labels from source domain to fine-tune it to make it adapt to the source domain. The fine-tuned teacher model can be used to generate pseudo labels for the large amount of unlabeled data from both source and target domains. The teacher and student model can exchange knowledge and the training schedules are repeated till convergence. Few-shot labeled data can be utilized in target domain to help select high quality pseudo labels.

At block 225, the BERT model can be post-trained on business-related documents to make BERT better represent the business entities and technical details.

At block 230, the vector representations for the features/entities extracted using the post-trained BERT model can be generated. Given a feature/entity, first it is tokenized by a Bidirectional Encoder Representations from Transformers (BERT) tokenizer to generate tokens, then the tokens are input together into the BERT model to generate embeddings for each token, the entity embedding can be generated by summing the embeddings of these tokens to obtain the final embedding of entity, which can be, for example, a 768 dimension vector. A vector representation vₓ=BERT(x) for text, x, which can be a sentence or noun phrase, can be generated. The BERT model can be post-trained on business/technical documents to make BERT better represent the features/details/entities in an application scenario.

At block 240, the positive unlabeled (PU) entities and features can be used to train a classifier to identify the technical details and business entities in the descriptive materials. A positive-unlabeled (PU) learning method can be used to train the classifier.

The training process of the feature classifier is described as follows. Given a positive entity set, P, and an unlabeled entity set U, and E=P∪U, where E is the whole feature (entity) set. In addition, there can be a vector representation vₑ of e∈E, where E is the entire feature set.

First: Fit a classifier (e.g., Random Forest) to predict the probability that a given feature/entity e∈E is labeled, p(s=1|vₑ).

Second: Use the classifier in Step 1 to predict the probability that the positive features are labeled, p(s=1|y=1|vₑ), e∈P. The mean of these predicted probabilities will be p(s=1|y=1).

Third: Use the classifier in Step 1 to estimate the probability that noun phrase, x, x∈E is labeled p(s=1|vₓ).

Fourth: By dividing p(s=1|vₓ) in Step 3 by p(s=1|y=1) in Step 2, we can get the probability the feature in x is a technical detail or entity.

At block 250, the labels and embedding vectors can be input into the trained classifier for training. Because there may be no labels for technical details and business entities, external data can be utilized to learn a feature classifier, F(vₓ), and transfer it to a business need domain. For each noun phrase, x, its vector representation vₓ (e.g., generated using a Bidirectional Encoder Representations from Transformers (BERT) model) is fed into the classifier, and the classifier judges whether the input noun phrase is a technical detail or business entity. The features that indicate company needs can be extracted from a specification sheet to represent a need document, where doc=(e₁, e₂, . . . , eₘ).

At block 260, noun phrases are extracted from the descriptive materials. For each noun phrase, x, whether it exists in a positive entity set can be checked.

Specifically, text data is first collected from national custom goods category and an industry category. With noun phrases extracted from them by existing tools, the extracted noun phrases can be treated as business entities and labeled as positive. In addition, the webpages of companies who list their needs can be collected, and an online named entity recognition (NER) tool can be used to identify the entities in the Consumer Good type as business entities and label them as positive. These business entities form a positive biz-entity set.

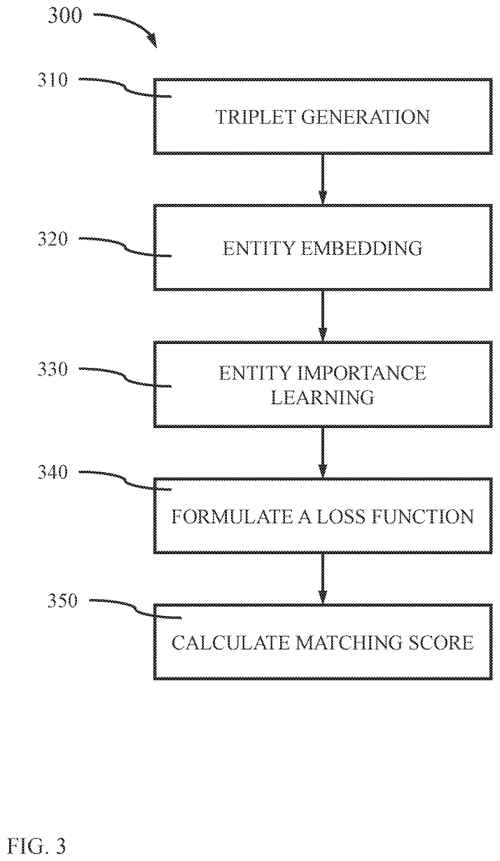

FIG. 3 is a block/flow diagram of a system/method for an entity importance recognizer is illustratively depicted in accordance with an embodiment of the present invention.

A procedure of feature/entity importance learning 300 can learn to identify the technical details of greatest importance to the user/consumer by extracting the features from a specification/needs document supplied by the user/consumer.

At block 310, triplets including the user's/consumer's needs document and the descriptive materials can be generated, where the descriptive materials can include a positive document and a negative document. For a given need document docᵢ, there are Mᵢ positive need documents and Nᵢ negative need documents, where positive means the need document pair is a match, and negative means the pair is not a match.

In various embodiments, there can be generated, Mᵢ*Nᵢ triplet (docᵢ, docₚ, doc_{q}) for docᵢ, where docₚ is a need document from the Mᵢ positives, and doc_{q} is a need document from the Nᵢ negatives. If there are K need documents (specification sheets), then in total we can generate:

T=Σᵢ₌₁^{k}Mᵢ*Nᵢ triplets, represented as T.

At block 320, the vector representations for the extracted features and entities can be generated using the post-trained BERT model. Given a feature/entity, first it is tokenized by a BERT tokenizer to generate tokens, then the tokens are input together into the BERT model to generate embeddings for each token, the entity embedding can be generated by summing the embeddings of these tokens to obtain the final embedding of entity, which can be, for example, a 768 dimension vector.

At block 330, entity importance is learned.

The importance of feature/entity, e, can be calculated by model H(vₑ). The above equation looks for its best match in E_{c}. To make the wₑ flexible and easy extend to unseen entities, we further model it as wₑ=H(vₑ)=vₑ* θ+b, where θ and b are two parameters to be learned.

Given a triplet t(docᵢ, docₚ, doc_{q}), where docₚ is a matched document of docᵢ, and doc_{q} is a unmatched document of docᵢ, we aim to learn the entity importance to maximize the matching score (calculated as above) between docᵢ and docₚ, meanwhile minimizing the matching score between docᵢ and doc_{q}. Given a triplet t(docᵢ, docₚ, doc_{q}), the parameters of H(ve) can be tuned to maximize the matching score between docᵢ and docₚ, meanwhile minimize the matching score between docᵢ and doc_{q}.

At block 340, a loss function can be formulated.

For each triplet, the loss function can be described as follows:

L(t)=max(0, (1−s_{i,p})−(1−s_{i,q})+α)

where α is a margin between positive and negative pairs.

Further with all the triplets in T, we can formulate the cost function, that is the sum of all losses, to be used for minimization of the following optimization problem. In this way, we can learn the entity importance for each entity, which later can be used for the matching score calculation.

L=Σ_{t∈T}L(t)

At block 350, a matching score can be calculated. Let E_{q} and E_{c} be entities appearing in Doc_{q} and Doc_{c}, respectively. The matching score, s, is evaluated by the following equation,

$${s}_{q , c} = {\sum }_{{e}_{q} ∈ {E}_{q}} {w}_{{e}_{q}} {max}_{{e}_{c} ∈ {E}_{c}} \frac{{v}_{{e}_{q}} \cdot {v}_{{e}_{c}}}{‖ {v}_{{e}_{q}} ‖ ‖ {v}_{{e}_{c}} ‖} ,$$

where vₑ denotes the vector semantic representation (e.g., word2vec) for feature/entity e, and wₑ is the importance for feature/entity, e.

For each pair of query and candidate documents, a feature-based matching score is used to evaluate the similarity of two need documents. A matching score can be calculated for each pair of the user's/consumer's specification document and the descriptive materials for a particular product from a vendor/manufacturer/developer.

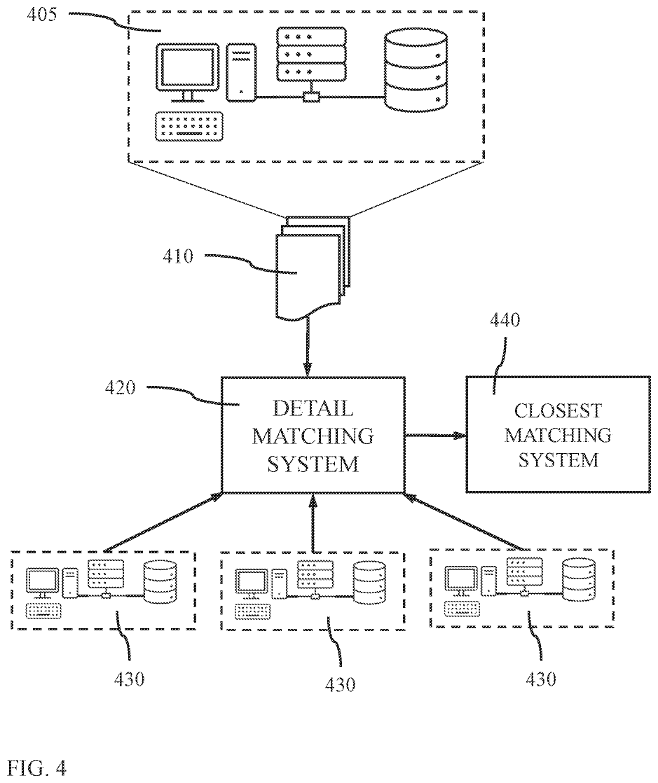

FIG. 4 is a block/flow diagram illustrating a process of receiving specification sheet(s) provided by a user/consumer and descriptive material from vendors/manufacturers/developers to identify computer systems/software that best meets the buyer's technical specifications, in accordance with an embodiment of the present invention.

In one or more embodiments, a detail matcher system 420 can execute a matching process 100 that identifies the best suited vendor product 430 from the descriptive materials available for the products 430 and outputs the closest matching system 440.

In block 410, the specification sheet(s) including the desired technical features/details provided by a prospective buyer can be inputted into the detail matching system 420. The various descriptive materials obtained for each of a plurality of vendor systems can be inputted into the detail matching system 420. The detail matching system 420 can perform a matching process 100 utilizing trained neural networks that extract the details from the specification sheet(s) and the descriptive materials available for the products 430. An importance model wₑ =H(vₑ) can be used to identify and calculate the importance of the various details, for example, to identify whether memory size, processor speed, number of cores, or bus speed is most important in relation to the available vendor products 430. A procurement order can be generated for the closest matching system 440 identified by the detail matching system 420.

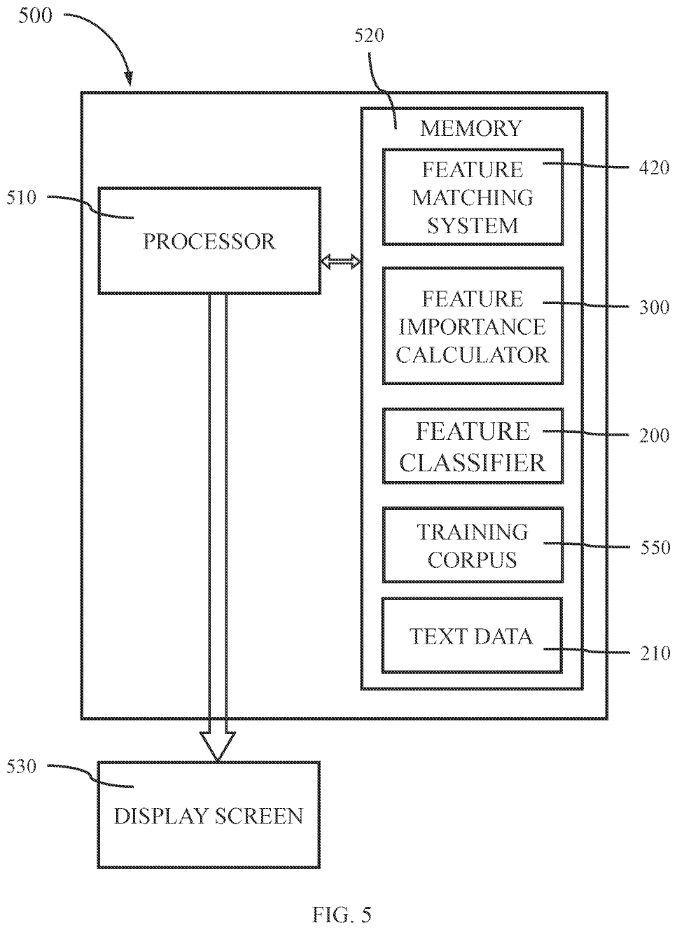

FIG. 5 illustrates a computer system for detail matching, in accordance with an embodiment of the present invention.

In one or more embodiments, the computer matching system 500 for detail/feature matching of technical features of computer systems and/or software can include one or more processors 510, which can be central processing units (CPUs), graphics processing units (GPUs), and combinations thereof, and a computer memory 520 in electronic communication with the one or more processors 510, where the computer memory 520 can be random access memory (RAM), solid state drives (SSDs), hard disk drives (HDDs), optical disk drives (ODD), etc. The memory 520 can be configured to store the detail matching tool 420, including a trained feature classifier 200, trained feature/entity importance calculator 300, training corpus 550, and collected text data 210. The feature classifier 200 can be a neural network configured to identify technical features and details in a specification sheet and in the collected text data 210. The feature/entity importance calculator 300 can be a neural network configured to determine the relative importance of each of the identified features/details in the provided specification sheets and descriptive materials. The training corpus 550 can be used to train the different neural networks, where the training corpus can contain external data. A display module can be configured to present an ordered list of the vendor products that match the customer's specification sheet(s) to a user on a display screen 530, as a summary of the available systems/software. The memory 520 and one or more processors 510 can be in electronic communication with a display screen 530 over a system bus and I/O controllers, where the display screen 530 can present the ranked list of available systems/software and/or prepare a procurement order for the highest ranked available system/software.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method of detail matching, comprising:
training a feature classifier to identify technical features;
training a neural network model for a trained importance calculator to calculate an importance value for each identified technical feature;
receiving a specification sheet including a plurality of technical features;
receiving a plurality of descriptive sheets each including a plurality of technical features;
identifying the technical features in the specification sheet and the plurality of descriptive sheets using the trained feature classifier;
calculating an importance for each identified technical feature using the trained feature importance calculator; and
calculating a matching score between the identified technical features of the specification sheet and the identified technical features of the plurality of descriptive sheets based on the importance of each identified technical feature.

2. The method of claim 1, wherein the trained importance calculator is trained using triplets of the specification sheet and the plurality of descriptive sheets.

3. The method of claim 2, further comprising generating vector embeddings for each identified technical feature using a trained Bidirectional Encoder Representations from Transformers (BERT) model.

4. The method of claim 3, wherein the matching scores, s_{q,c}, are calculated using
$${s}_{q , c} = {\sum }_{{e}_{q} ∈ {E}_{q}} {w}_{{e}_{q}} {max}_{{e}_{c} ∈ {E}_{c}} \frac{{v}_{{e}_{q}} \cdot {v}_{{e}_{c}}}{‖ {v}_{{e}_{q}} ‖ ‖ {v}_{{e}_{c}} ‖} ,$$
wherein vₑ denotes a vector semantic representation for each feature/entity e, and wₑ is the importance for each feature/entity, e.

5. The method of claim 4, wherein training the feature classifier utilizes a positive feature set, P, and an unlabeled feature set, U, where E=P∪U, where E is the whole feature set.

6. The method of claim 4, wherein matched documents are utilized to train the entity importance model H(vₑ)=wₑ, where yₑ is the vector representation of feature, e, and wₑ is the learned feature importance.

7. The method of claim 6, wherein the parameters of the entity importance model H(vₑ)=wₑ, are tuned based on a loss function, L(t)=max(0,(1−s_{i,p})−(1−s_{i,q})+α).

8. A computer system for detail matching, comprising:
one or more processors;
a computer memory in electronic communication with the one or more processors; and
a display screen in electronic communication with the computer memory and the one or more processors;
wherein the computer memory includes:
a feature classifier trained to identify technical features;
a neural network model configured as a trained importance calculator for calculating an importance value for each identified technical feature;
text data including a specification sheet including a plurality of technical features, and a plurality of descriptive sheets each including a plurality of technical features, wherein the trained feature classifier identifies the technical features in the specification sheet and the plurality of descriptive sheets;
a feature importance calculator to calculate an importance for each identified technical feature using the trained feature importance calculator; and
a feature matching system to calculate a matching score between the identified technical features of the specification sheet and the identified technical features of the plurality of descriptive sheets based on the calculated importance of each identified technical feature, wherein a closest matching product is presented to a user on the display screen.

9. The computer system of claim 8, wherein the trained importance calculator is trained using triplets of the specification sheet and the plurality of descriptive sheets.

10. The computer system of claim 9, wherein feature classifier generates vector embeddings for each identified technical feature using a trained Bidirectional Encoder Representations from Transformers (BERT) model.

11. The computer system of claim 10, wherein the matching scores, s_{q,c}, are calculated using
$${s}_{q , c} = {\sum }_{{e}_{q} ∈ {E}_{q}} {w}_{{e}_{q}} {max}_{{e}_{c} ∈ {E}_{c}} \frac{{v}_{{e}_{q}} \cdot {v}_{{e}_{c}}}{‖ {v}_{{e}_{q}} ‖ ‖ {v}_{{e}_{c}} ‖} ,$$
wherein vₑ denotes a vector semantic representation for each feature/entity e, and wₑ is the importance for each feature/entity, e.

12. The computer system of claim 11, wherein training the feature classifier utilizes a positive feature set, P, and an unlabeled feature set, U, where E=P∪U, where E is the whole feature set.

13. The computer system of claim 11, wherein matched documents are utilized to train the entity importance model H(vₑ)=wₑ, where vₑ is the vector representation of feature, e, and wₑ is the learned feature importance.

14. The computer system of claim 13, wherein the parameters of the entity importance model H(vₑ)=wₑ, are tuned based on a loss function, L(t)=max(0,(1−s_{i,p})−(1−s_{i,q})+α).

15. A non-transitory computer readable storage medium comprising a computer readable program for detail matching, wherein the computer readable program when executed on a computer causes the computer to perform the steps of:
training a feature classifier to identify technical features;
training a neural network model for a trained importance calculator to calculate an importance value for each identified technical feature;
receiving a specification sheet including a plurality of technical features;
receiving a plurality of descriptive sheets each including a plurality of technical features;
identifying the technical features in the specification sheet and the plurality of descriptive sheets using the trained feature classifier;
calculating an importance for each identified technical feature using the trained feature importance calculator; and
calculating a matching score between the identified technical features of the specification sheet and the identified technical features of the plurality of descriptive sheets based on the importance of each identified technical feature.

16. The non-transitory computer readable storage medium comprising a computer readable program of claim 15, wherein the trained importance calculator is trained using triplets of the specification sheet and the plurality of descriptive sheets.

17. The non-transitory computer readable storage medium comprising a computer readable program of claim 16, further comprising generating vector embeddings for each identified technical feature using a trained Bidirectional Encoder Representations from Transformers (BERT) model.

18. The non-transitory computer readable storage medium comprising a computer readable program of claim 17, wherein the matching scores, s_{q,c}, are calculated using
$${s}_{q , c} = {\sum }_{{e}_{q} ∈ {E}_{q}} {w}_{{e}_{q}} {max}_{{e}_{c} ∈ {E}_{c}} \frac{{v}_{{e}_{q}} \cdot {v}_{{e}_{c}}}{‖ {v}_{{e}_{q}} ‖ ‖ {v}_{{e}_{c}} ‖} ,$$
wherein vₑ denotes a vector semantic representation for each feature/entity e, and wₑ is the importance for each feature/entity, e.

19. The non-transitory computer readable storage medium comprising a computer readable program of claim 18, wherein training the feature classifier utilizes a positive feature set, P, and an unlabeled feature set, U, where E=P∪U, where E is the whole feature set.

20. The non-transitory computer readable storage medium comprising a computer readable program of claim 18, wherein matched documents are utilized to train the entity importance model H(vₑ)=wₑ, where vₑ is the vector representation of feature, e, and wₑ is the learned feature importance, and the parameters of the entity importance model H(vₑ)=wₑ, are tuned based on a loss function, L(t)=max(0,(1−s_{i,p})−(1−s_{i,q})+α).
